(19) United States
(12) Patent Application Publication
(10) Pub. No.: US 2007/0268209 A1
(43) Pub. Date: Nov. 22, 2007

(54) Imaging Panels Including Arrays Of Audio And Video Input And Output Elements

(76) Inventor: Kenneth Wargon, Manly (AU)

Correspondence Address: JOHN R. BENEFIEL, 525 Lewis Street, BIRMINGHAM, MI, 48009, US

(21) Appl. No.: 11/748,624

(22) Filed: May 15, 2007

Related U.S. Application Data
(60) Provisional application No. 60/800,731, filed on May 16, 2006.

(51) Int. Cl. G09G 3/20

(52) U.S. Cl. 345/55

(57) ABSTRACT

Arrays of audio and video input and output elements are combined in various combinations in an imaging panel. The audio input and output elements may take the form of miniature speakers and microphones manufactured utilizing CMOS-MEMS technology. The video imaging input and output elements may take the form of display elements such as LCD's and elements such as CMOS light detectors or CCD's capable of sensing an image. The arrays of audio and video elements may be interspersed or partially segregated, and be distributed homogeneously or non-homogeneously.

### CROSS REFERENCE TO RELATED APPLICATIONS

This application claims the benefit of U.S. provisional application Ser. No. 60/800,731 filed on May 16, 2006.

### BACKGROUND OF THE INVENTION

There have heretofore been described miniature audio elements to perform the functions of a microphone or a speaker.

See for examples of such audio elements the following which are incorporated herein by reference.
1) “Digital Sound Reconstruction Using Arrays of CMOS-MEMS Microspeakers” published on Jun. 8-12, 2003 by IEEF, INSPEC ACCESSION No. 7936579 By Diamond, B. M., Neumann, J. J., Gabriel, K. J. This paper also appears in: Micro Electro Mechanical Systems, 2002. The Fifteenth IEEE International Conference on Page(s): 292-295; 2002
2) “Method And Apparatus For Reconstruction Of Soundwaves From Digital Signals”, U.S. Pat. No. 7,089,069 B2, Aug. 8, 2006
3) “Ultrathin Form Factor MEMS Microphones And Microspeakers”, U.S. Pat. No. 6,936,524 B2
4) “MEMS Digital-To-Acoustic Transducer With Error Cancellation”, WO 2001/020948, Publication Date 22 Mar. 2001

In U.S. Pat. No. 6,936,524 B2, MEMS (Micro-Electro-Mechanical Systems) devices manufactured using CMOS technology are described as being useable as either miniature speakers or miniature microphone elements.

Arrays of miniature speakers have also been described in the above referenced U.S. Pat. No. 7,089,069 B2 entitled “Method And Apparatus For Reconstruction Of Soundwaves From Digital Signals”, and the “Digital Sound Reconstruction Using Arrays of CMOS-MEMS Microspeakers” article referenced above in which arrays can produce true digital reconstructions of sound, as described therein.

The miniaturized configuration of these devices offers certain advantages over traditional speakers as detailed in these cited publications including the ability to utilize micromachining manufacturing techniques, improved performance, minimized component space requirements, etc.

There has also been developed small video imaging elements, such as LCD (liquid crystal display) elements, which are now in widespread use in electronic displays for televisions, cameras, cell phones, computer monitors, etc. These elements are arranged in an array in a display panel which are activated in such a way as to jointly produce an image made up of pixels, each comprised of an individual video imaging element.

There also have been in widespread use light sensors such as CMOS light sensors and CCD'S (charged coupled devices) for imaging purposes such as in digital cameras.

U.S. Pat. No. 7,034,866 B1 entitled “Combined Display-Camera For An Image Processing System”, dated Apr. 25, 2006, and Patent application WO 2004/107301 A1 entitled “Photoelectric Element And Terminal Equipment Including A Photoelectric Element”, International Publication Date Dec. 9, 2004, and U.S. Patent application US2006/0007222A1 entitled “Integrated Sensing Display”, dated Jan. 12, 2006 are incorporated herein by reference, and describe an integrated sensing display in which an array of display elements is located within a display area, and an array of image sensing elements is also located within the same display area. Thus, both a display and a camera are provided in the same space. Certain advantages accrue from such a combination as described in these referenced publications.

It is an object of the present invention to provide an imaging panel including both audio and video elements.

### SUMMARY OF THE INVENTION

In the present invention, small video and audio elements are integrated into a common array forming an imaging panel which is a combination of audio sensing (i.e. MEMS microphones) and/or audio reproducing elements (i.e. MEMS speakers) together with video image sensing (i.e. CMOS image sensors) and/or video image displaying (i.e. LCD) elements, to provide both audio and video functions in a single device. The video imaging elements form a video image. Such elements include conventional LCD display elements such as those used in television displays, and/or video image sensing elements such as CMOS image sensors, or CCD's found in digital cameras. The audio elements are typically on the same order of size or smaller than the video imaging elements so as to not interfere substantially with the image display.

Various combinations of the audio and video elements which comprise the imaging panel are possible, i.e. a device comprising audio sensing, audio reproducing, video imaging sensing, and video imaging displaying elements all present in a common array provides for the recording and reproducing of both sound and images with an imaging panel that may be used in an audio-video conferencing monitor. Such an imaging panel based monitor allows an initial person located in front of such a monitor to view displayed information (or a secondary person whom they are interacting with) while hearing audio emanating from the monitor (i.e. audio originating from the secondary person), while at the same time such monitor also captures and transmits both the image of said initial person along with the initial person's spoken words that are directed towards the monitor and transmitted to the secondary person.

Such an imaging panel based device has many advantages over current audio-video conferencing setups which typically require a computer display device that is hooked-up to an external speaker(s), external microphone, and external camera (e.g., “webcam” video image capture device) components. This current configuration typically utilizes various obtrusive cabling schemes and wiring conduits along with the burdensome use of table or mounting space for these bulky components that may not always be available; thus requiring an extended hardware set-up time as well as an increased likelihood of malfunction due to the number of components and their associated interconnections. Similarly, such a current configuration lacks the ease of portability that an essentially one-piece imaging panel based device provides.

Another example of the present invention is of an imaging panel based device that comprises both audio reproducing elements along with video imaging displaying elements in a common array to provide for the provision of both sound and images, as in a television or computer monitor. Advantages of these image panel based devices include those as described above.

The audio signal input elements, i.e. sound reproducing elements, may comprise speaker elements receiving input signals from an audio signal source to produce sound. A stereo effect may be achieved by two or more separate audio signals transmitted to speakers in different spaced apart areas of an array of audio signal input elements in an imaging panel. Other effects may be achieved by sending differing signals to respective elements in different areas of the imaging panel. These signals may be generated by suitable software and/or hardware.

### DESCRIPTION OF THE DRAWINGS.

FIG. 1 is diagrammatic representation of an imaging panel having arrays of audio and video elements thereon according to the invention.

FIG. 2 is a diagrammatic representation of an imaging panel having arrays of audio input elements and audio output elements combined with arrays of video imaging input elements and video imaging output elements together with a block diagram of associated components.

FIG. 3 is a diagrammatic representation of an imaging panel having arrays of audio output elements and video imaging output elements and a block diagram of associated components.

FIG. 4 is a diagrammatic representation of an imaging panel having arrays of audio input elements and video imaging input elements together with a block diagram of associated components.

FIG. 5 is a diagrammatic representation of an imaging panel having arrays of audio input elements and video imaging output elements with a block diagram of the associated components.

FIG. 6 is a diagrammatic representation of an imaging panel having arrays of audio output elements and video imaging input elements with a block diagram of the associated components.

FIG. 7 is a diagrammatic representation of an imaging panel having arrays of audio input elements, audio output elements, and video imaging output elements together with a block diagram of associated components.

FIG. 8 is a diagrammatic representation of audio input and output elements combined on an imaging panel with video imaging input elements and a block diagram of associated components.

FIG. 9 is a diagrammatic representation of an imaging panel having arrays of audio output elements combined with video imaging input and output elements and a block diagram representation of associated components.

FIG. 10 is a diagrammatic representation of an imaging panel having arrays of audio input elements and arrays of video imaging input and output elements together with a block diagram representation of associated components.

FIG. 11 is a plan view of a cell phone with an imaging panel having video and audio elements mounted thereon.

FIG. 12 is a front view of a television display formed by video imaging elements on an imaging panel also including audio signal input speaker elements.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to FIG. 1, according to the present invention, audio elements 10 and video elements 12 are combined in a generally planar imaging panel 14 to provide related functions in one device. The elements are shown diagrammatically as being relatively large for clarity, but would typically be much smaller i.e., the size of pixels in computer monitor displays or smaller.

These audio elements may comprise one or more arrays of audio signal input elements (i.e., sound reproducing elements such as CMOS-MEMS speakers) and audio signal output elements (i.e., sound sensing elements such as CMOS-MEMS microphones) such as described in U.S. Pat. No. 6,936,524 B2 referred to above.

An array of video elements may comprise video imaging signal input elements (i.e., image producing elements such as LCD's) collectively forming a displayed image, and video imaging signal output elements (i.e., light sensing elements such as CMOS light sensors, CCD's, or photosensors) collectively providing a camera function as described in U.S. Pat. No. 7,034,866 B1, published application U.S. 2006/0007222A1, and published application WO 2004/107301 A1.

Each audio or video array may be comprised of groupings of constituent elements.

These video imaging signal input elements may be arranged in an array on the imaging panel 14 comprised of vertical and horizontal crossing rows as shown in FIG. 1, or various other patterns with various differing proportions of other arrays of audio and/or video elements; or, with equal numbers of each as required for a particular application. The distribution of each type of audio and video element may be homogeneous throughout the imaging panel or non-homogeneous. As such, certain areas of the imaging panel may be devoid of particular audio or video elements. The various audio and video elements 10 and 12 may also be partially or completely segregated in the imaging panel 14. Such flexible layouts/arrangements of the various audio and video elements are also applicable to the various imaging panels exemplified by FIGS. 1-12. Typically, the imaging elements 12 which form an image would be greater in number than the audio elements 10 to achieve greater resolution of the images sensed or displayed.

Each video imaging signal input element Vᵢ provides one pixel of the image displayed.

The audio elements are sized to be sufficiently small so as to not substantially interfere with the video image display produced by the array of video image display elements (i.e., LCD's). The audio elements may be sized on the order of an individual display pixel or smaller in order to achieve this, such as by use of the CMOS-MEMS audio elements referenced above.

Thus, audio and video imaging functions are enabled by the single imaging panel 14 to save manufacturing costs, save space, and provide for a thin profile one-piece design.

The specifications and functionality of each individual audio and video element in an imaging panel may differ from the specifications and functionality of other audio and video elements in the same imaging panel. This enables varying operating characteristics for individual elements or groups of elements in order to fulfill the requirements of each particular application. For example, speakers (or microphones) may have different frequency responses from other speakers (or microphones) in the same imaging panel. Similarly, video imaging display elements (i.e., LCD's) and video imaging sensing elements (i.e., CMOS MEMS camera elements) may have varying spectral responses compared to other video imaging display or sensing elements in the same imaging panel.

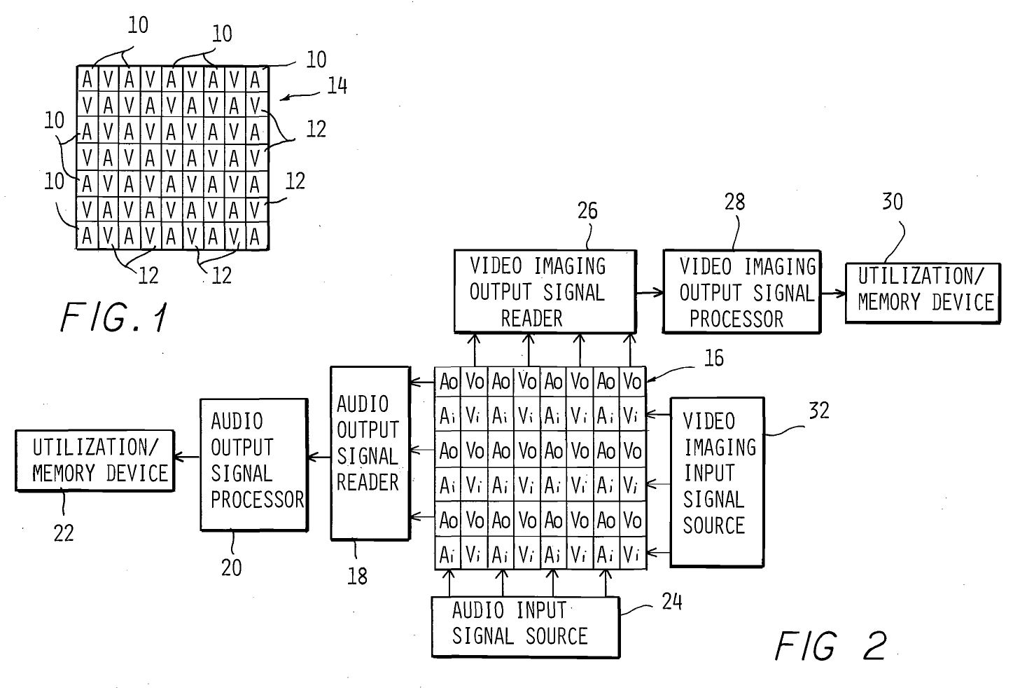

Referring to FIG. 2, both audio signal input elements Aᵢ, i.e. CMOS-MEMS speakers, and audio signal output elements Aₒ, i.e. CMOS-MEMS microphones as well as video imaging signal output elements Vₒ (such as CMOS light sensors, or CCD's) and video imaging signal input elements Vᵢ (such as LCD's) may all be combined in a single imaging panel 16.

Audio signal output elements Aₒ such as microphones are interspersed with audio signal input elements Aᵢ such as speakers. Video imaging signal output elements Vₒ such as camera elements, i.e., CMOS light sensors, CCD's or similar devices are also included on the same imaging panel 16. Lenses (not shown) may be utilized in conjunction with the video imaging elements Vₒ in order to generate acceptable images for a particular application, such as described in U.S. 2006/0007222A1 and U.S. Pat. No. 7,034,866 B1 referenced above.

Also included are video imaging signal input elements Vᵢ such as LCD's. The various elements Aₒ, Aᵢ, Vₒ and Vᵢ are depicted as being evenly interspersed on the imaging panel 16 but other distributions may be employed to achieve any desired particular purpose. The audio signal output elements Aₒ each generate audio output signals which are read by an audio output signal reader 18. These signals would typically be processed in an audio output signal processor 20 used to operate a utilization (such as an external speaker) or memory device 22 for storing the audio signals. Such audio output signal processor 20 may use technology and algorithms well known in the art to mix or otherwise produce signals with desired acoustical characteristics from signals obtained from audio signal output elements Aₒ.

The audio signal input elements Aᵢ are connected to an audio input signal source 24 to drive the audio signal input elements such as the speakers described above to produce sound.

Similarly, the video imaging signal output elements Vₒ, such as CMOS light sensors or CCDs, transmit their output signals to a video imaging output signal reader 26. A video imaging output signal processor 28 then prepares the signals prior to utilizing the signals in a utilization/memory device 30. Such video imaging output signal processor 28 may use technology and algorithms well known in the art to assemble a final image from data obtained from video imaging signal output elements V₀.

A video imaging signal source 32 is connected to the video imaging signal input elements Vᵢ (such as LCD's) to produce an image by the array of elements Vᵢ.

Thus, the single imaging panel 16 is capable of recording and displaying video imaging signals and broadcasting and recording audio signals.

It should be understood that elements Aₒ, Aᵢ, Vₒ, and Vᵢ may be integrated into imaging panel 16 by using CMOS techniques, but the specific connections which are apparent to one skilled in the art are not shown in order to simplify and improve the clarity of the drawings. Of course, other fabrication processes and techniques may also be employed.

An example of the use of this imaging panel 16 is the bi-directional audio-visual conferencing monitor described above.

The diagrammatic representations of various functional groups and their interrelationships, e.g., audio output signal reader 18, audio output signal processor 20, and utilization/memory device 22 are examples of some of the possible configurations of various panel embodiments. Numerous other examples, variants, and configurations are possible and are apparent to those skilled in the art.

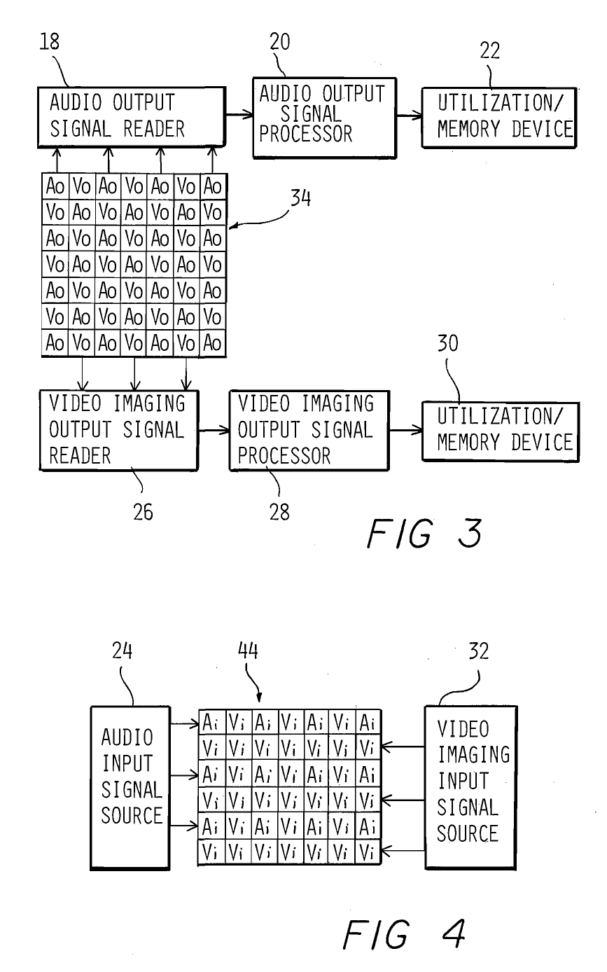

FIG. 3 shows an imaging panel 34 comprised of audio signal output elements Aₒ and video imaging signal output elements Vₒ. The audio signal output elements Aₒ are connected as before to an audio output signal reader 18. These signals may then be processed in an audio output signal processor 20 and then sent to a utilization/memory device 22.

Similarly, the video imaging signal output elements Vₒ, such as CMOS light sensors, CCDs, or photosensors, transmit their output signals to a video imaging output signal reader 26. A video imaging output signal processor 28 then prepares the signals prior to utilizing the signals in a utilization/memory device 30. This imaging panel 34 could be used in a video-audio recorder or other applications.

FIG. 4 depicts an imaging panel 44 wherein an array of audio signal input elements Aᵢ is combined with an array of video imaging signal input elements Vᵢ.

In this imaging panel 44, an audio input signal source 24 is connected to the audio signal input elements Aᵢ, such as the CMOS MEMS speakers referred to above, and a video imaging input signal source 32 connected to the video imaging signal input elements Vᵢ, such as LCD's. Thus a single device 44 can provide both sound and video playback as in a television or monitor, control panel, entertainment/game display, communication (i.e. mobile) devices, and a multitude of other applications.

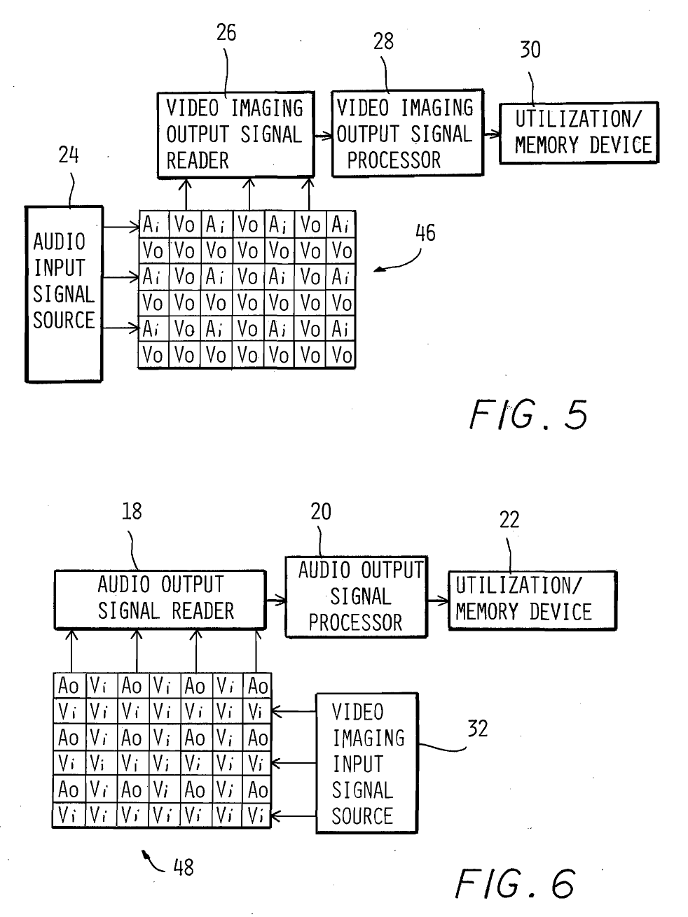

FIG. 5 illustrates imaging panel 46 which incorporates audio signal input elements Aᵢ, such as the CMOS MEMS speakers described above. The audio signal input elements Aᵢ are connected to an audio input signal source 24. The imaging panel 46 also includes interspersed video imaging signal output elements Vₒ connected to a video imaging output signal reader 26; video imaging output signal processor 28 and then to a utilization/memory device 30.

This device allows an audio message to be broadcast, as for example audio instructions or prompts, to aid in camera use while video images are being recorded, and may also be employed in other applications.

FIG. 6 shows another embodiment in the form of imaging panel 48 which includes audio signal output elements Aₒ interspersed with video imaging signal input elements Vᵢ.

An audio output signal reader 18 is connected to the audio signal output elements Aₒ whereby the audio output signal reader 18 is then connected to audio output signal processor 20 which in turn is connected to a memory/utilization device 22.

A video imaging input signal source 32 is connected to the video imaging signal input elements Vᵢ to generate a display by the array 48. This device would be useful to provide visual prompting while recording an audio signal in utilization/memory device 22, and may also be used in other applications.

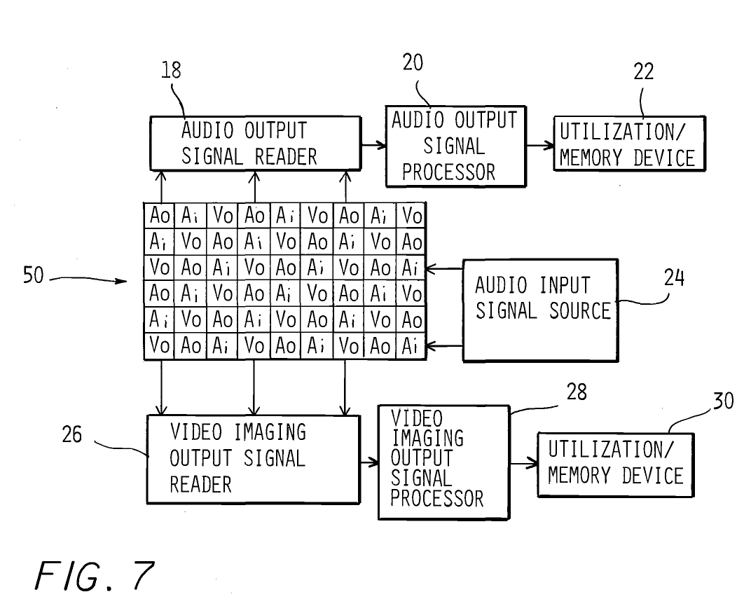

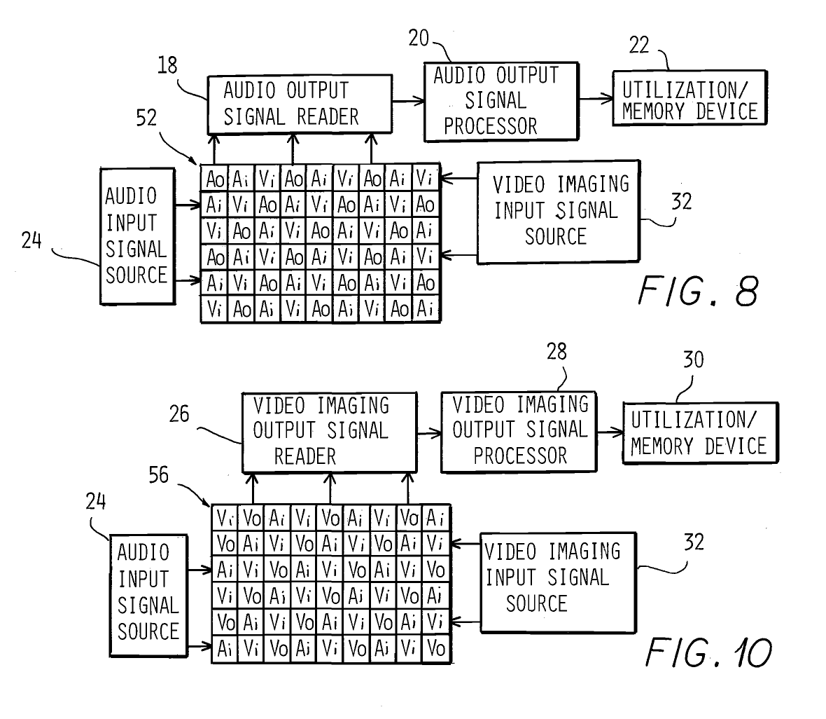

FIGS. 7-10 illustrate some various other possible combinations of audio and video elements that may be combined in an imaging panel.

FIG. 7 shows an imaging panel 50 in which audio signal input and output elements Aᵢ, Aₒ are combined with video imaging signal output elements Vₒ. The audio signal input elements Aᵢ, such as CMOS MEMS speakers are connected to an audio input signal source 24, while the audio signal output elements Aₒ are connected to an audio output signal reader 18, then connected to an audio output signal processor 20, and then connected to a utilization/memory device 22.

The video imaging signal output elements Vₒ are connected to a video imaging output signal reader 26, in turn connected to a video imaging output signal processor 28 and then utilization/memory device 30. This device would be useful in video monitoring applications such as where audible 2-way communications between medical personnel and a patient can take place while the medical personnel can concurrently view the patient. In this application, there is no need for the patient to view the medical staff. Other applications for this device are also applicable.

The FIG. 8 depicted imaging panel combines audio signal input and output elements Aᵢ, Aₒ, with video imaging signal input Vᵢ elements on an imaging panel 52. The audio signal input elements Aᵢ are connected to an audio input signal source 24, and the audio signal output elements Aₒ are connected to an audio output signal reader 18, in turn connected to an audio output signal processor 20 and then utilization or memory device 22.

The video imaging signal input elements Vᵢ are connected to a video imaging input signal source 32. Such a device could combine a visual display with an audio recorder with a playback capability, such as in a display monitor with bi-directional audio capability. This device may also be employed in other applications.

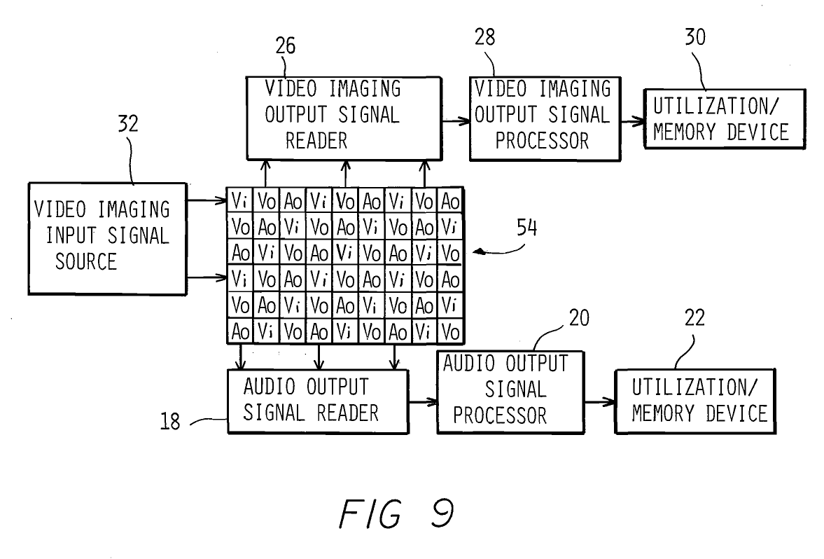

FIG. 9 shows an imaging panel 54 combining video imaging signal input and output elements Vᵢ and Vₒ with audio signal output elements Aₒ. The video image signal input elements Vᵢ, such as LCD's are connected to a video imaging input signal source 32.

The video imaging signal output elements Vₒ, are connected to a video imaging output signal reader 26 in turn connected to a video imaging output signal processor 28 and then utilization/memory device 30. Audio signal output elements Aₒ are connected to an audio output signal reader 18, in turn connected to an audio output signal processor 20 and then utilization or memory device 22. Such a device 54 could be used in a video recorder/display device without audio playback. An example of an application of this device 54 is in an instructor's conferencing monitor used in remote teaching environments where an instructor's image is captured for presentation to a room of remotely located students, while a video image of the students is presented to the instructor, as the instructor provides verbal lessons to said students as the instructor's voice is captured by audio signal output elements Aₒ.

FIG. 10 shows an imaging panel 56 which includes video imaging signal input and output elements Vᵢ, Vₒ combined with audio signal input elements Aᵢ.

The video imaging signal input elements Vᵢ, are connected to a video imaging input signal source 32. The video imaging signal output elements Vₒ are connected to a video imaging output signal reader 26, in turn connected to a video imaging output signal processor 28, which in turn is connected to a utilization or memory device 30. The audio signal input elements Aᵢ are connected to an audio input signal source 24. Such imaging panel 56 could be used with a video recorder and display device having audio promptings during video recording, as well as in other applications.

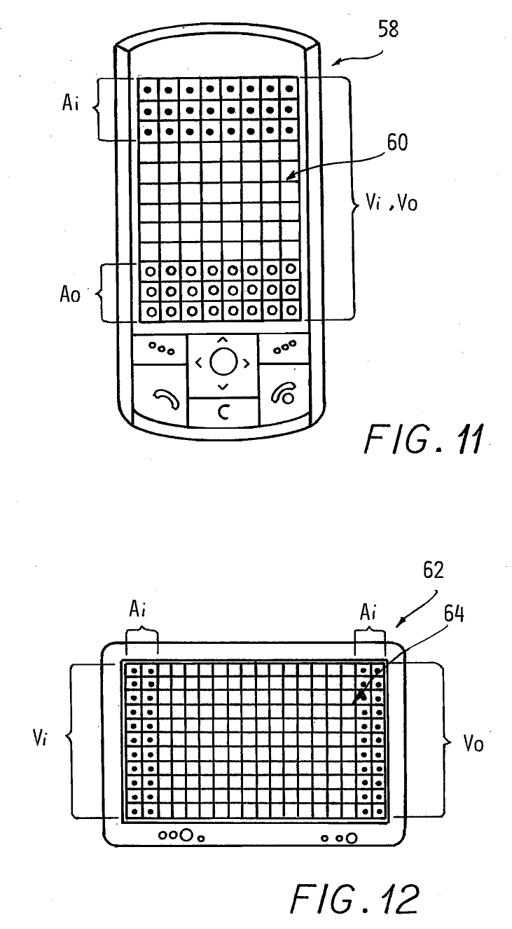

FIG. 11 illustrates a cell phone 58 combined with an imaging panel 60 which has an upper region including an array of audio signal input elements Aᵢ in the form of speakers such as CMOS MEMs speakers The entire imaging panel 60 includes video imaging signal input elements Vᵢ to provide a visual display, and also may include video imaging signal output elements Vₒ to provide a cell phone camera.

The bottom region of imaging panel 60 has audio signal output elements A₀ arrayed therein in the form of microphones such as CMOS-MEMS microphones. Thus, the imaging panel 60 may provide both audio and video functions. The imaging panel 60 may also have some or all of the above described audio and video elements dispersed throughout the entire array 60 area.

It should be appreciated that the imaging panel 60 according to the invention doesn't necessarily require that the various audio and video elements be interspersed throughout the entire array area, but some regions may have some elements segregated or dispersed only therein.

Note that the above described imaging panel 60 of audio and video elements replaces the dedicated display component and microphone and speaker assemblies commonly found in mobile communication devices, thus freeing up the valuable limited space often dedicated both above and below the display screen to accommodate separate speaker and microphone assemblies. By replacing these three independent component assemblies (display, microphone, and speaker) with the one imaging panel 60 of this invention, the size/area of the display screen may thus be enlarged by utilizing the space previously utilized by the microphone and speaker assemblies. This enlarged display area is thus accomplished without enlarging the physical size of the cell phone. Other advantages of the use of imaging panel 60 include higher reliability due to a lower component count, less macro interconnections thus allowing faster assembly time, and reduced inventories of individual repair service parts.

The above described imaging panel may similarly be used in PDAs (personal digital assistants), various mobile and non-mobile communication devices, telephones, and numerous other devices such as control panels, game/entertainment interfaces/displays, advertising kiosks and displays, consoles, etc.

FIG. 12 shows a TV/Computer Monitor/Conferencing Monitor 62 in combination with an imaging panel 64 which is comprised of arrays of elements according to the present invention. Audio signal input elements Aᵢ here may take the form of arrays of speakers occupying regions on either side of the imaging panel 64, while video imaging signal input elements Vᵢ may occupy the entire area of the imaging panel 64. Thus, both audio and video are provided by a single device. For video conferencing, video imaging signal output elements Vₒ may also be included distributed across the entire imaging panel 64, or areas thereof to add image capture (camera) functionality. An array of audio output elements Aₒ such as MEMs microphones may also be distributed within the array of video elements to enable the capture of sounds directed towards monitor 62 to enable video conferencing. The audio/visual elements Aₒ. Aᵢ, Vₒ and Vᵢ may be distributed in a variety of positions, proportions, and distributions in order to fulfill the requirements of each particular application.

Note that the just described imaging panel based conferencing monitor 62 eliminates the traditional use of external peripherals such as cameras, microphones, and speakers along with their associated space occupying support fixtures and associated cables. The imaging panel implementation thus creates a robust, low weight, compact, reliable, self-contained audio/visual system.

The use of CMOS-MEMS speaker and microphone elements may advantageously be combined with CMOS light sensors as video imaging elements, as the attractive economics of CMOS techniques in manufacturing can be realized, but other fabrication processes and elements may also be employed.

The positions of the audio signal input and output element arrays may be located in a common plane of the imaging panel along with the video imaging signal input and output element arrays.

Each audio signal output or input element may occupy its own discrete position, or each position may contain various combinations of audio signal input elements, audio signal output elements, video image signal input elements, and/or video image signal output elements.

The text in this specification often refers to an “imaging panel”. This term is not meant to limit the scope of the medium which contains or supports the various discussed input and output elements (e.g., microphones, speakers, video imaging signal input and output elements) to a planar medium or structure that functions only as a display. Such input and output elements may occupy other two or three dimensional areas, regions, or spaces.

Another example of the use of the technology of the present invention is its implementation with reflective mirrors or transparent (or non-transparent) windows or other surfaces, media, or spaces. In such applications, audio signal input element arrays such as described above may be incorporated with such media so that a person may hear audio emanating from the media. Similarly, video imaging signal input element arrays such as described above may also be incorporated with the media to display information. Applications that incorporate this technology enable a transparent window to act as a television display and audio system whereby a person in a room obtains visual images and sound from a device, structure, or area that otherwise would simply function as i.e., a window. Such “smart windows” save table space that may not be available (to accommodate a traditional television) and also eliminates the need for a television stand. This audio-visual system would be connected to electronics that normally control television operation.

Due to the small size and visual non-obtrusiveness (or near unobtrusiveness) of the audio/visual element arrays, media such as a window still serves its original function. An on-off switch can simply disable the visual display (e.g., LCD) elements so that a person can see through the window without distraction. Such “smart windows” can effectively serve as an advertisement media in outdoors bus stops or advertising kiosks. Without taking up additional space, media that is merely used to provide a static or otherwise non audio/visual advertisement to a consumer can now be used to display various i.e. computer controlled images from various advertisers as well as video and sound. As previously described, audio signal output element arrays and video imaging signal output element arrays may also be incorporated into such implementations.

1. An imaging panel comprising:
a panel;
an array of video display elements extending over on said panel, each video element forming a pixel of images formed by activating said video display elements by video input signals received from a source of said video input signals so as to form said images;
one or more arrays of audio elements extending over said imaging panel at least partially interspersed with said array of said video display elements, and said audio elements sized to be sufficiently small so as to not substantially interfere with images displayed by said video display elements and said audio elements capable of reproducing sound when receiving audio signals from an audio signal source and/or sensing sound and producing output signals corresponding to said sensed sound, whereby an image display and one or more audio functions are provided by said imaging panel.

2. The imaging panel according to claim 1, wherein said one or more arrays of audio elements includes an array of said audio elements capable of reproducing sound.

3. The imaging panel according to claim 1 wherein said one or more arrays of audio elements includes an array of said audio elements capable of sensing sound.

4. The imaging panel according to claim 2 wherein said one or more arrays of audio elements also include an array of said audio elements capable of sensing sound.

5. The imaging panel according to claim 1 further including an array of image sensing video elements collectively producing output signals corresponding to images sensed collectively by said array of image sensing video elements, said image sensing video elements small enough to not substantially interfere with images produced by said array of video display elements whereby said imaging panel also may function as a camera.

6. The imaging panel according to claim 1 wherein said audio elements include an array of audio elements capable of reproducing sound and comprise CMOS MEMS speakers.

7. The imaging panel according to claim 4 in combination with a cellular telephone.

8. The imaging panel according to claim 2 in combination with a television.

9. The imaging panel according to claim 2 in combination with a computer monitor.

10. The imaging panel according to claim 1 wherein said audio elements comprise CMOS-MEMS speakers or CMOS-MEMS microphones.

11. The imaging panel according to claim 1 wherein said video display elements comprise LCD's.

12. The imaging panel according to claim 5 wherein said image sensing video elements comprise CCD (charged coupled device) light sensors.

13. The imaging panel according to claim 5 wherein said image sensing video elements comprise CMOS light sensors.

14. The imaging panel according to claim 1 wherein one of said one or more arrays of audio elements are substantially completely interspersed with said video display elements.

15. The imaging panel according to claim 1 wherein at least some of said audio elements are segregated together on said panel.

16. The imaging panel according to claim 1 wherein said video display elements and said audio elements are distributed non-homogeneously over said imaging panel.

17. The imaging panel according to claim 1 wherein said video display elements and said audio elements are distributed homogeneously over said imaging panel.

18. An imaging panel comprising:
a panel;
an array of video elements extending over said panel, each video element comprising a pixel of images generated by sensing or displaying images by said video elements;
one or more arrays of audio elements extending over said imaging panel at least partially interspersed with said array of said video elements and sized to be sufficiently small so as to not substantially interfere with images generated by said video elements, said audio elements capable of reproducing sound when receiving audio signals from an audio signal source and/or of sensing sound and producing output signals corresponding to said sensed sound, whereby one or more imaging functions are provided by said imaging panel.

19. The imaging panel according to claim 18, wherein said one or more arrays of audio elements includes an array of said audio elements capable of reproducing sound.

20. The imaging panel according to claim 18 wherein said one or more arrays of audio elements includes an array of said audio elements capable of sensing sound.

21. The imaging panel according to claim 19 wherein said one or more arrays of audio elements also include an array of said audio elements capable of sensing sounds.

22. The imaging panel according to claim 18 wherein said video elements include video display elements.

23. The imaging panel according to claim 22 wherein said video elements also including video sensing elements.

24. The imaging panel according to claim 18 wherein said video elements comprise video sensing elements.

25. The imaging panel according to claim 18 in combination with a cellular telephone.

26. The imaging panel according to claim 18 in combination with a computer monitor.

27. The imaging panel according to claim 18 in combination with a conferencing monitor.

28. The imaging panel according to claim 18 wherein said video elements and said audio elements are distributed non-homogeneously over said imaging panel.

29. The imagining panel according to claim 18 wherein said video elements and said audio elements are distributed homogeneously over said imaging panel.
